(19) United States
(12) Patent Application Publication
(10) Pub. No.: US 2022/0370991 A1
(43) Pub. Date: Nov. 24, 2022

(54) METHOD FOR ONE-STEP CREATION OF BIMETALLIC-CONTAINING LAMELLAR ZEOLITE CATALYSTS

(71) Applicant: U.S. Army DEVCOM Army Research Laboratory, Adelphi, MD (US)

(72) Inventors: Laleh Emdadi, Centreville, VA (US); Dat T. Tran, Clarksville, MD (US); Sampath Gunukula, Beltsville, MD (US)

(21) Appl. No.: 17/323,448

(22) Filed: May 18, 2021

(51) Int. Cl. B01J 29/78; B01J 29/76; B01J 37/30; B01J 37/00; B01J 37/06; B01J 37/10; B01J 35/02; B01J 35/10; B01J 37/04; B01J 37/08

(52) U.S. Cl. CPC B01J 29/78; B01J 29/76; B01J 37/30; B01J 37/0018; B01J 37/06; B01J 37/009; B01J 37/10; B01J 35/026; B01J 35/1057; B01J 35/1061; B01J 37/04; B01J 37/08; B01J 2229/26; B01J 2229/183

(57) ABSTRACT

Incorporating a bimetal to a lamellar MFI zeolite structure includes providing a bimetallic-incorporated lamellar zeolite catalyst including a sodium source, aluminum source, silicon source, surfactant, sulfuric acid, deionized water, metal source, and molecular template; dissolving the sodium source in the deionized water creating a basic solution; adding the sulfuric acid, aluminum source, molecular template, and silicon source to the basic solution creating a mixture and adding the metal source to the mixture; dissolving the surfactant in the deionized water creating a surfactant solution; combining the surfactant solution and basic solution; heating the combined surfactant solution and basic solution in a rotating autoclave creating a metal-containing zeolite including the surfactant and molecular template in a structure of the metal-containing zeolite; removing a synthesized zeolite from the autoclave; drying the synthesized zeolite and creating a dry zeolite powder; calcining the dry zeolite powder creating a bimetal-containing lamellar MFI zeolite for chemical activation.

### GOVERNMENT INTEREST

The embodiments herein may be manufactured, used, and/or licensed by or for the United States Government without the payment of royalties thereon.

### BACKGROUND

### Technical Field

The embodiments herein generally relate to material synthesis, and more particularly to processing techniques for creating bimetallic-containing lamellar zeolite catalysts.

### Description of the Related Art

Conventional state-of-the art technologies for making metal incorporated zeolite structures involve a range of impregnation methods such as wet impregnation techniques to incorporate bimetals on to zeolite supports. These techniques are multi-step. First, the zeolite is synthesized and then the impregnation is carried out over the synthesized zeolite to add the metals to the zeolite catalyst structure. Such impregnation techniques predominantly result in the formation of bulk metal oxides. However, bulk metal oxides usually result in a low catalytic activity especially with the oxidation reactions. Moreover, the conventional techniques for bimetallic-incorporated zeolite catalyst synthesis using the impregnation technique generally result in oligomeric cationic metal complexes and neutral metal-oxide clusters as well as larger metal-oxide aggregates on the zeolite support instead of isolated metal sites in the zeolite framework that have higher activity and/or selectivity for the desired reactions such as deoxygenation of biomass-derived compounds, which lowers the catalytic activity and stability of these bimetallic-zeolite catalysts.

### SUMMARY

In view of the foregoing, an embodiment herein provides a method to incorporate a bimetal to a lamellar MFI zeolite structure, the method comprising providing a bimetallic-incorporated lamellar zeolite catalyst comprising a sodium source, an aluminum source, a silicon source, a surfactant, sulfuric acid, deionized (DI) water, a metal source, and a molecular template; dissolving the sodium source in the DI water to create a basic solution; adding the sulfuric acid, the aluminum source, the molecular template, and the silicon source to the basic solution to create a mixture and then adding the metal source to the mixture in the basic solution; dissolving the surfactant in the DI water to create a surfactant solution; combining the surfactant solution with the basic solution; heating the combined surfactant solution and the basic solution in a rotating autoclave to create a metal-containing zeolite including the surfactant and the molecular template in the structure of the metal-containing zeolite; removing a synthesized zeolite from the autoclave; drying the synthesized zeolite to create a dry zeolite powder; calcining the dry zeolite powder to remove the surfactant and the molecular template to create a bimetal-containing lamellar MFI zeolite structure; and chemically activating the bimetal-containing lamellar MFI zeolite structure.

The bimetal-containing lamellar MFI zeolite structure may comprise micropores of less than 1 nm and mesopores of 2-50 nm. The sodium source may comprise sodium hydroxide. The aluminum source may comprise aluminum sulfate. The silicon source may comprise tetraethyl orthosilicate (TEOS). The metal source may comprise a metal nitrate solution. The surfactant may comprise a polyquaternary ammonium structure of [C₂₂H₄₅-N⁺(CH₃)₂-C₆H₁₂-N⁺(CH₃)₂-C₆H₁₃]Br₂, C₂₂₋₆₋₆. The molecular template may comprise tetrapropylammonium hydroxide (TPAOH). The bimetallic-incorporated lamellar zeolite catalyst may comprise metal dopants containing any of (i) Ni and Fe, and (ii) Ni and Mn. The weight percent of each metal in the bimetallic-incorporated lamellar zeolite catalyst that is synthesized may be between 0-2.5.

The heating may occur at a temperature of 150° C. The autoclave may rotate at a speed of 30 rpm. The heating may occur for 5 days. The amount of the bimetal-containing lamellar MFI zeolite structure that is produced from 30 mL of the zeolite synthesis solution (e.g., the combined surfactant solution and the basic solution) may be 1-1.8 g. The method may comprise cooling metal-containing zeolite at ambient room temperature prior to removal of the synthesized zeolite from the autoclave. The method may comprise washing and centrifugation of the synthesized zeolite prior to the drying, wherein the washing occurs in DI water until a pH of 9 is obtained. After drying, the synthesized zeolite may be calcined at 600° C. for 6 hours to remove the surfactant and the molecular template. The method may comprise activating the bimetal-containing lamellar MFI zeolite structure by performing a catalyst preparation process comprising performing an ion-exchange process on the calcined dry zeolite powder; drying an ion-exchanged zeolite powder; and activating the dry zeolite powder by heating prior to running a catalytic reaction thereon.

The ion-exchange process may comprise (a) dissolving an ammonium nitrate powder in DI water to create a 1M ammonium nitrate solution; (b) mixing the calcined dry zeolite powder with the 1M ammonium nitrate solution having a weight ratio of 1 to 10 to create an ion-exchange mixture; (c) heating the ion-exchange mixture at 80° C. for 2 hours; (d) washing and centrifugation of the ion-exchange mixture with DI water to separate zeolite from the ion-exchange mixture; and (e) repeating the steps (b) through (d) multiple times. The catalyst preparation method may comprise heating the dry zeolite powder after ion-exchange at 550° C. for 4 hours to activate the dry zeolite powder.

These and other aspects of the embodiments herein will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a flow diagram illustrating a method to incorporate a bimetal to a lamellar MFI zeolite structure, according to an embodiment herein;

FIG. 2 is a flow diagram illustrating an activating process of the method of FIG. 1, according to an embodiment herein;

FIG. 3 is a flow diagram illustrating an ion-exchange process of the activating process of FIG. 2, according to an embodiment herein;

FIG. 4 is a schematic diagram illustrating a production process of bimetal-containing lamellar MFI zeolite production using the one-step hydrothermal synthesis method of FIG. 1, according to an embodiment herein;

FIG. 5 is a schematic diagram illustrating the hypothetical bimetal-containing lamellar MFI zeolite formation mechanism using the one-step hydrothermal synthesis method of FIG. 1, according to an embodiment herein;

FIG. 6A is a scanning electron microscopy (SEM) image of lamellar MFI zeolite synthesized using a conventional method, according to an embodiment herein;

FIG. 6B is an enhanced view of the SEM image of FIG. 6A showing lamellar MFI zeolite synthesized using a conventional method, according to an embodiment herein;

FIG. 6C is a SEM image of 2.5% Ni-2.5% Fe-lamellar MFI zeolite synthesized using the one-step hydrothermal synthesis method of FIG. 1, according to an embodiment herein;

FIG. 6D is an enhanced view of the SEM image of FIG. 6C showing 2.5% Ni-2.5% Fe-lamellar MFI zeolite synthesized using the one-step hydrothermal synthesis method of FIG. 1, according to an embodiment herein;

FIG. 6E is a SEM image of 2.5% Ni-2.5% Mn-lamellar MFI zeolite synthesized using the one-step hydrothermal synthesis method of FIG. 1, according to an embodiment herein;

FIG. 6F is an enhanced view of the SEM image of FIG. 6E showing 2.5% Ni-2.5% Mn-lamellar MFI zeolite synthesized using the one-step hydrothermal synthesis method of FIG. 1, according to an embodiment herein;

FIG. 7 is a graphical representation of wide-angle X-ray diffraction (XRD) patterns of lamellar MFI, 2.5% Ni-2.5% Fe-lamellar MFI, and 2.5% Ni-2.5% Mn-lamellar MFI zeolites synthesized using the one-step hydrothermal synthesis method of FIG. 1, according to an embodiment herein; and

FIG. 8 is ultraviolet-visible (UV-Vis) spectra of lamellar MFI, 2.5% Ni-2.5% Fe-lamellar MFI, and 2.5% Ni-2.5% Mn-Lamellar MFI zeolites synthesized using the one-step hydrothermal synthesis method of FIG. 1, according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

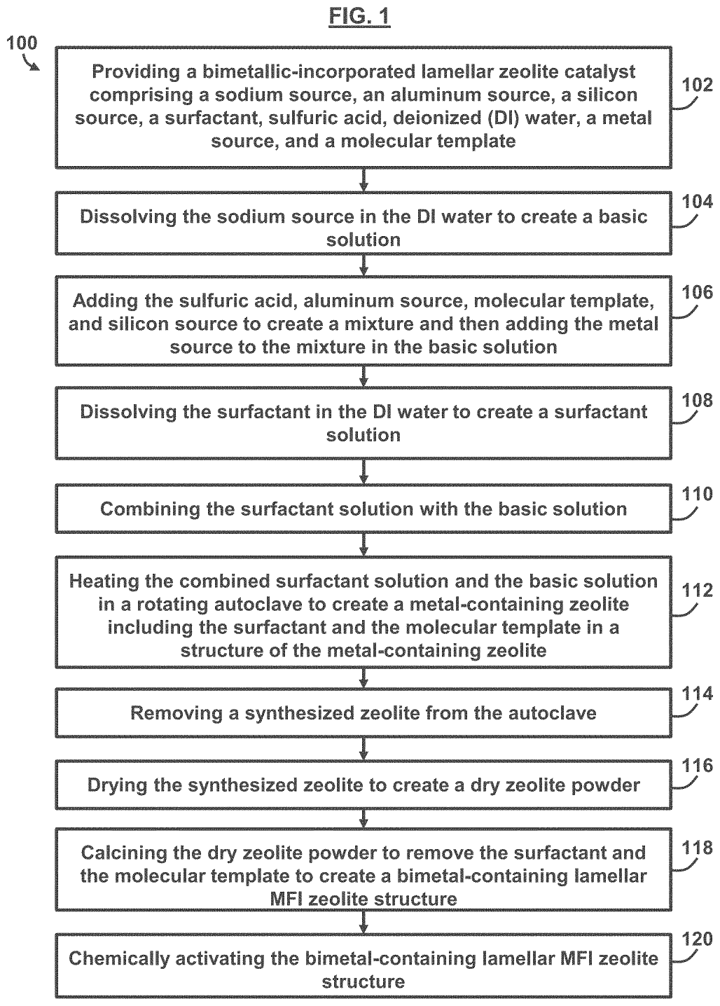

The embodiments herein provide a one-step hydrothermal synthesis of bimetallic-incorporated lamellar zeolite catalysts that results in the formation of isolated metal sites in the zeolite framework, which can enhance the catalytic activity and/or selectivity as well as stability of the catalyst for oxidation reactions. The catalysts produced in accordance with the embodiments herein may be used for deoxygenation of biomass derived compounds to efficiently produce value added chemicals/fuels, according to an example. Referring now to the drawings, and more particularly to FIGS. 1 through 8, where similar reference characters denote corresponding features consistently throughout the figures, there are shown preferred embodiments.

The creation of value-added chemicals and fuels from biomass-derived compounds through deoxygenation on-site is an important reaction to reduce the logistical burdens and improve the industry to fully utilize biomass sources and lower the impact of the produced waste materials on the environment. One catalyst is not able to perform the different types of elementary reaction steps required to deoxygenate biomass-derived compounds. For this reason, considerable attention has been placed on multifunctional catalysts, such as bimetallic catalysts, where different active materials are used to facilitate these diverse reaction steps. As mentioned, the available bimetallic catalysts are usually produced by an impregnation technique over zeolites, which is a multi-step method and results in formation of metal oxide species on zeolite that are not as active as metals in the zeolite catalyst framework. Accordingly, the embodiments herein provide a technique where the bimetallic (e.g., Ni—Mn and Ni—Fe)-incorporated lamellar MFI zeolite catalysts are synthesized using a one-step hydrothermal synthesis method. The synthesized bimetallic-incorporated zeolites were experimentally characterized, as described below, by scanning electron microscopy (SEM), powder X-ray diffraction (XRD), and ultraviolet-visible (UV-Vis)-diffuse reflectance spectroscopy (DRS).

FIGS. 1 through 3 are flow diagrams illustrating a method 100 to incorporate a bimetal to a lamellar MFI zeolite structure. According to some examples, a traditional laboratory set-up may be used to perform the method 100 including carrying out the mixing of the various components in a traditional laboratory fume hood and utilizing traditional laboratory equipment such as lab dishes, trays, vials, and canisters to hold various components and utilizing beakers, measuring cylinders, and flasks to combine the various components together, among other types of equipment. Moreover, traditional glass or magnetic stirrers and corresponding hot plates may be used for stirring the various components. Furthermore, a standard laboratory oven with a rotating tray may be used for heating the various components. Additionally, other traditional laboratory equipment may be used to carry out the method 100 herein.

According to an embodiment herein, the method 100 comprises providing (102) a bimetallic-incorporated lamellar zeolite catalyst using a sodium source, an aluminum source, a silicon source, a surfactant, sulfuric acid, deionized (DI) water, a metal source, and a molecular template. The amount of each of these chemicals depends on the amount of zeolite to be produced. For example, an autoclave with 30 mL volume for the zeolite synthesis solution that can produce 1-1.8 gram zeolite at the end may utilize: 0.7 gram sodium source, 0.2373 gram aluminum source, 6.27 gram silicon source, 2.1876 gram surfactant, 0.4 gram sulfuric acid, 23 gram DI water, 0.4 to 0.5 gram metal source, and 0.765 gram molecular template, according to some examples. However, as mentioned, these amounts may be different based on the amount of zeolite to be produced, and the embodiments herein are not restricted to these particular amounts. According to an example, the various components may be provided in separate laboratory dishes and/or beakers, etc. and used as needed in accordance with the subsequent steps of the method 100 as further described below.

In an example, the sodium source may comprise sodium hydroxide. In an example, the aluminum source may comprise aluminum sulfate. In an example, the silicon source may comprise tetraethyl orthosilicate (TEOS). In an example, the metal source may comprise a metal nitrate solution. In an example, the surfactant may comprise a polyquaternary ammonium structure of [C₂₂H₄₅-N⁺(CH₃)₂-C₆H₁₂-N⁺(CH₃)₂-C₆H₁₃]Br₂, C₂₂₋₆₋₆. In an example, the molecular template may comprise tetrapropylammonium hydroxide (TPAOH). The bimetallic-incorporated lamellar zeolite catalyst may comprise metal dopants containing any of (i) Ni and Fe, and (ii) Ni and Mn.

Next, the method 100 comprises dissolving (104) the sodium source in the DI water to create a basic solution. According to an example, for an autoclave with the capacity of a 30 mL zeolite synthesis solution that produces around 1-1.8 gram zeolite at the end of the process, a 4 gram basic solution or 4 mL basic solution may be used. In an example, the dissolving process (104) may be completed in a vial or beaker with gentle agitation using a magnetic stirring bar. According to an example, the dissolving process (104) may take between 60-300 seconds. Moreover, the dissolving process (104) may occur at room temperature, in an example.

Next, the method 100 comprises adding (106) the sulfuric acid, the aluminum source, the molecular template, the silicon source, and the metal source to the basic solution. The adding process (106) may occur according to a specific sequence of adding the various components to the basic solution. First, the sulfuric acid is added to the basic solution, then the aluminum source is added to the basic solution, after that the molecular template is added, and finally the silicon source is added. This mixture is stirred at room temperature using a magnetic stir bar at 800-1000 rpm for 20-24 hours, according to an example. After that, the metal source is added to the resulting mixture and this new mixture is stirred at room temperature for 2-3 hours at 800-1000 rpm (before adding the surfactant solution to the mixture).

Next, the method 100 comprises dissolving (108) the surfactant in the DI water to create a surfactant solution. According to an example, for an autoclave with the capacity of a 30 mL zeolite synthesis solution that produces around 1-1.8 gram zeolite at the end of the process, a 15 gram surfactant solution or 10-15 mL surfactant solution may be used. In an example, the dissolving process (108) may be completed in a plastic vial or beaker with gentle agitation using a magnetic stirring bar at 60° C. According to an example, the dissolving process (108) may take between 5-15 minutes at 60° C. Moreover, the dissolving process (108) may occur at room temperature for a longer time such as 24 hours, in an example.

Next, the method 100 comprises combining (110) the surfactant solution with the basic solution mixture. In an example, the surfactant solution is added to the basic solution mixture. In another example, the basic solution mixture is added to the surfactant solution. Moreover, the combining process (110) may be completed in a vial or beaker with agitation at 800-1000 rpm using a magnetic stirring bar. According to an example, the combining process (110) may take between 1-2 hours to ensure full mixing of the surfactant solution with the basic solution mixture and formation of necessary precursors for zeolite synthesis. Moreover, the combining process (110) may occur at room temperature, in an example.

Next, the method 100 comprises heating (112) the combined surfactant solution and the basic solution in a rotating autoclave to create a metal-containing zeolite including the surfactant and the molecular template in a structure of the metal-containing zeolite. In an example, the autoclave, which is placed in a laboratory oven, may comprise a Teflon®-lined stainless-steel autoclave. According to an example, the heating process (112) may occur at a temperature of 150° C. (e.g., in the laboratory oven) and for approximately 4-6 days, and preferably for 5 days. Additionally, the autoclave may rotate at a speed of 30 rpm, in an example.

Next, after a cooling process, the method 100 comprises removing (114) a cooled synthesized zeolite from the autoclave. Accordingly, in an example, the synthesized zeolite may be cooled prior to removal from the autoclave. In particular, the metal-containing zeolite may be cooled at ambient room temperature prior to removal of the synthesized zeolite from the autoclave.

Next, the method 100 comprises drying (116) the synthesized zeolite to create a dry zeolite powder. The drying process (116) may occur in an oven at 70° C. for 20-24 hours, for example. The method 100 may comprise washing and centrifugation (e.g., in a traditional laboratory centrifuge) of the synthesized zeolite at 5000-10000 rpm for 5-15 minutes, for example, prior to the drying process (116). In an example, the washing and centrifugation occurs using DI water and is repeated until a pH of 9 is obtained.

Next, the method 100 comprises calcining (118) the dry zeolite powder to remove the surfactant and the molecular template to create a bimetal-containing lamellar MFI zeolite structure. In an example, the calcining process (118) may occur in a furnace or kiln, etc. Moreover, after the drying process (116), the synthesized zeolite may be calcined at 600° C. for 6 hours to remove the surfactant and the molecular template, according to an example. Furthermore, the bimetal-containing lamellar MFI zeolite structure may comprise micropores of less than 1 nm and mesopores of 2-50 nm, according to an example. Additionally, in an example, the amount of the bimetal-containing lamellar MFI zeolite structure that is produced from 30 mL of the combined surfactant solution and basic solution may be 1-1.8 g. According to an example, the weight percent of each metal in the bimetallic-incorporated lamellar zeolite catalyst that is synthesized may be between 0-2.5.

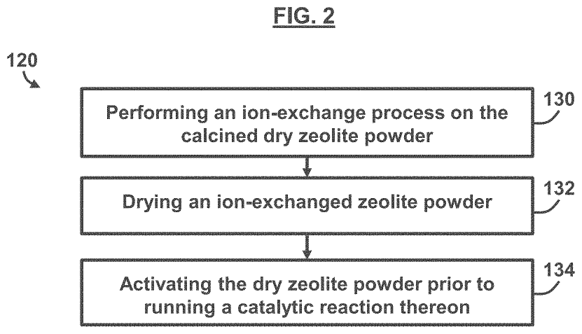

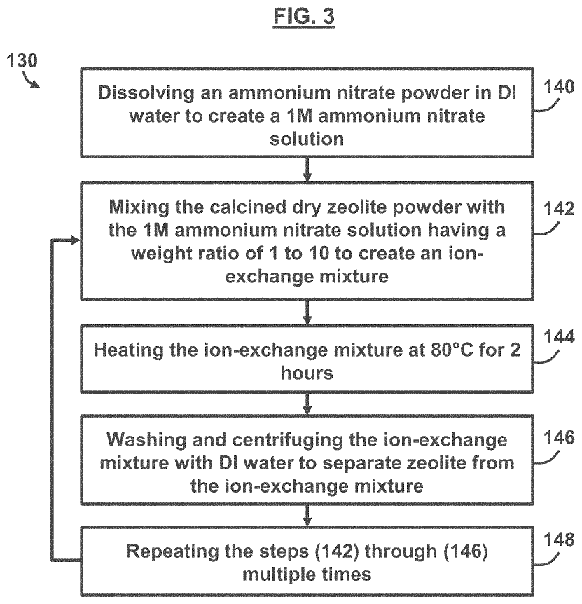

Next, the method 100 comprises chemically activating (120) the bimetal-containing lamellar MFI zeolite structure. As shown in the flow diagram of FIG. 2, the activating process (120) of the bimetal-containing lamellar MFI zeolite structure may occur by performing a catalyst preparation process comprising performing (130) an ion-exchange process on the calcined dry zeolite powder. The ion-exchange process is described with reference to FIG. 3. Next, as indicated in FIG. 2, the activating process (120) comprises drying (132) an ion-exchanged zeolite powder. The drying process (132) may occur by removal of any moisture in the ion-exchanged zeolite powder using an oven at 70° C. for 20-24 hours, for example. Next, the activating process (120) comprises activating (134) the dry zeolite powder prior to running a catalytic reaction thereon. During the activating (134), the acid form or H+ form of zeolite is created which is active for reactions. For example, the activating (134) may comprise heating the dry zeolite powder after ion-exchange at 550° C. for 4 hours to activate the dry zeolite powder.

As shown in the flow diagram of FIG. 3, the ion-exchange process (130) of FIG. 2 may comprise dissolving (140) an ammonium nitrate powder in DI water to create a 1M ammonium nitrate solution. According to an example, the dissolving process (140) may take between 60-300 seconds. Moreover, the dissolving process (140) may occur at room temperature, in an example.

Next, the ion-exchange process (130) comprises mixing (142) the calcined dry zeolite powder with the 1M ammonium nitrate solution having a weight ratio of 1 to 10 to create an ion-exchange mixture. In an example, the mixing process (142) may occur at room temperature and may take between 60-120 seconds. Furthermore, the calcined dry zeolite powder may be added to the 1M ammonium nitrate solution or the 1M ammonium nitrate solution may be added to the calcined dry zeolite powder, according to various examples.

Next, the ion-exchange process (130) comprises heating (144) the ion-exchange mixture at 80° C. for 2 hours. Next, the ion-exchange process (130) comprises a washing and centrifugation process (146) wherein the ion-exchanged zeolite mixture is washed and centrifuged with DI water to separate zeolite from the ion-exchange mixture. The washing and centrifugation process occur together. First, the ion-exchange zeolite mixture is poured in a centrifuge tube (to fill half of the tube volume) and then DI water is added to the centrifuge tube to fill the centrifuge tube to its full standard capacity, and then the centrifugation is run for 5-15 minutes if the centrifugation rotation speed is between 5000-10000 rpm, for example. Next, the ion-exchange process (130) comprises repeating (148) the steps (142) through (146) multiple times. In an example, the steps (142) through (146) may be repeated three times, although other amounts of repetition may be utilized in accordance with the embodiments herein.

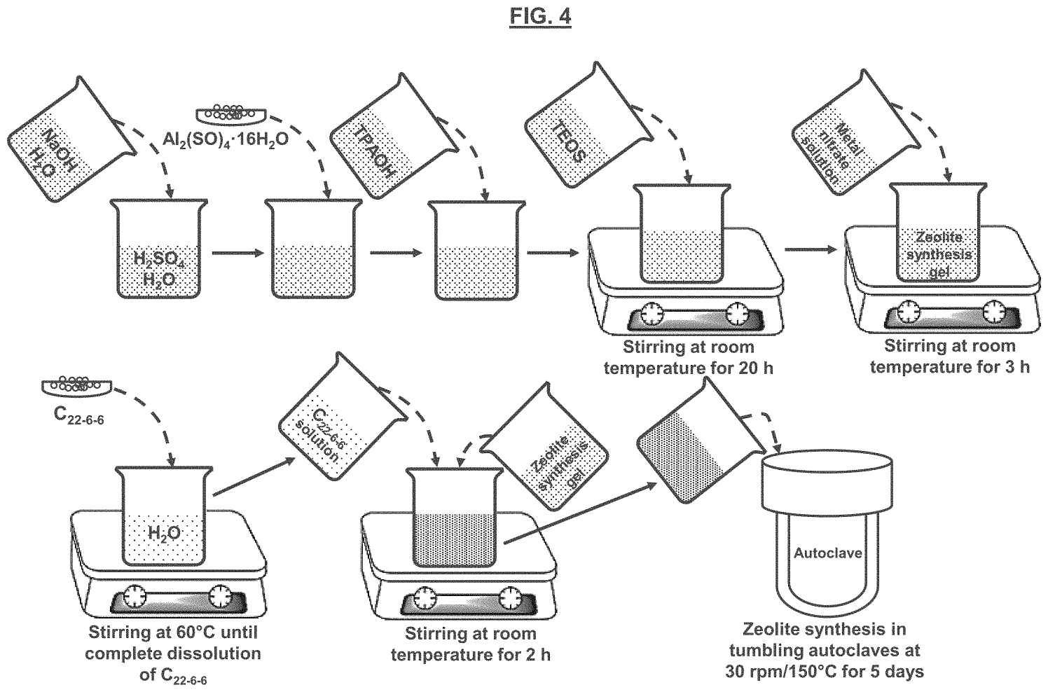

FIG. 4 is a schematic diagram illustrating the production process of bimetal-containing lamellar MFI zeolite using the one-step hydrothermal synthesis method 100 described above with reference to FIG. 1. The bimetallic-containing zeolite catalysts with lamellar structure are prepared using a one-step hydrothermal synthesis technique for making high energy density chemicals via pyrolysis pathway to meet the on-demand energy at the point of need. According to an example, the metal pairs nickel (Ni) and manganese (Mn) as well as nickel (Ni) and iron (Fe) are incorporated to lamellar MFI zeolite structure via one-step hydrothermal synthesis method 100.

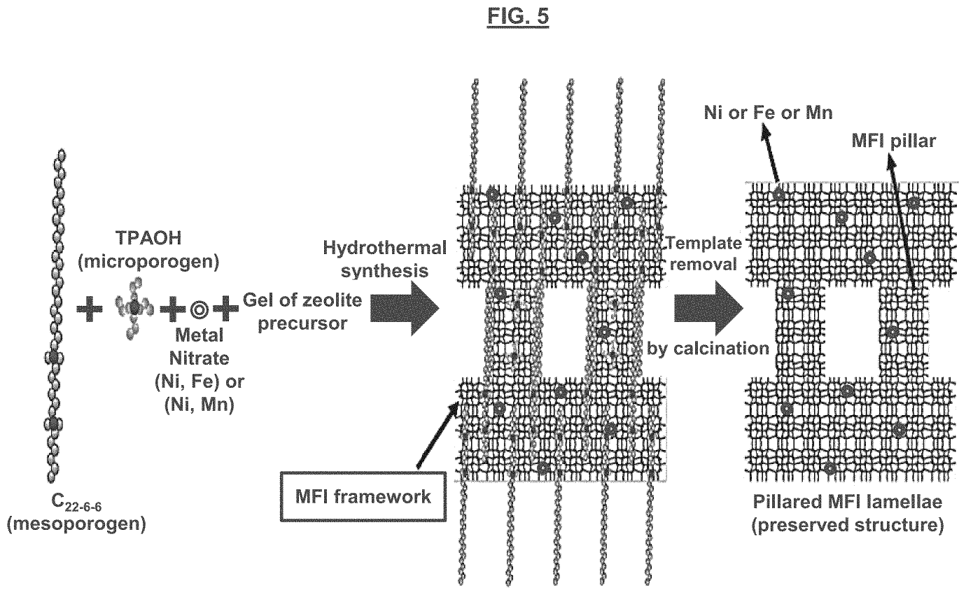

FIG. 5 is a graphic diagram illustrating a hypothesized scheme for bimetal-containing lamellar MFI zeolite formation using the one-step hydrothermal synthesis method 100 described above with reference to FIG. 1. FIG. 5 shows that when the molecular template (e.g., TPAOH) and the surfactant molecule (e.g., C₂₂₋₆₋₆) are mixed with the metal source (which comprises a metal nitrate solution) and gel of zeolite precursor including the aluminum and silicon sources, the TPAOH is acting as microporogen co-operatively with the C₂₂₋₆₋₆ to form the MFI zeolite nanosheets around the C₂₂₋₆₋₆ ammonium head-groups and the zeolite pillars between the zeolite nanosheets, while the C₂₂ alkyl tail of C₂₂₋₆₋₆ is directing the formation of the lamellar-type nanosheet structure by its intermolecular assembly as mesoporogen. The metal precursors are distributed inside the micropores and mesopores of the resulting lamellar MFI zeolite and when the TPAOH and C₂₂₋₆₋₆ are removed from the zeolite structure by calcination, the meso-/microporous structure of the lamellae zeolite is preserved due to the presence of metal-containing zeolite pillars.

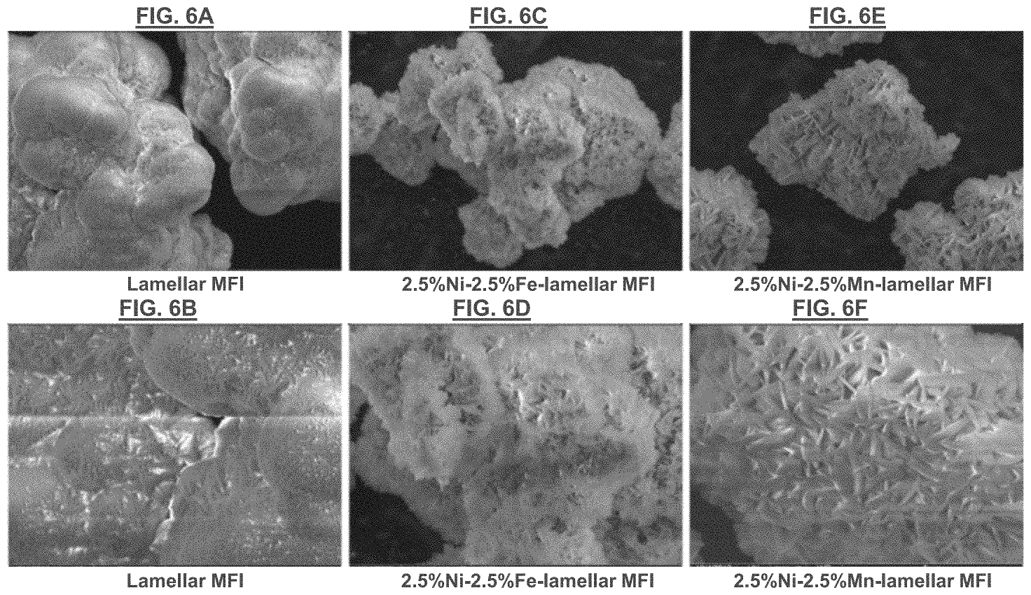

FIGS. 6A and 6B are SEM images of lamellar MFI synthesized using the conventional solutions. FIGS. 6C and 6D are SEM images of 2.5% Ni-2.5% Fe-lamellar MFI zeolite synthesized using the one-step hydrothermal synthesis method 100 described above with reference to FIG. 1. FIGS. 6C and 6D show the same sample but at different magnification. It can be seen that adding the metals into the MFI zeolite structure using method 100 does not sacrifice the layered structure of the zeolite since the Ni and Fe-containing zeolite shown in FIGS. 6C and 6D has the similar morphology to that of the zeolite without metal components shown in FIGS. 6A and 6B. FIGS. 6E and 6F are SEM images of 2.5% Ni-2.5% Mn-lamellar MFI zeolite synthesized using the one-step hydrothermal synthesis method 100 described above with reference to FIG. 1. It can be seen that adding the metals into the MFI zeolite structure using method 100 does not sacrifice the layered structure of the zeolite since the Ni and Mn-containing zeolite shown in FIGS. 6E and 6F has the similar morphology to that of the zeolite without metal components shown in FIGS. 6A and 6B.

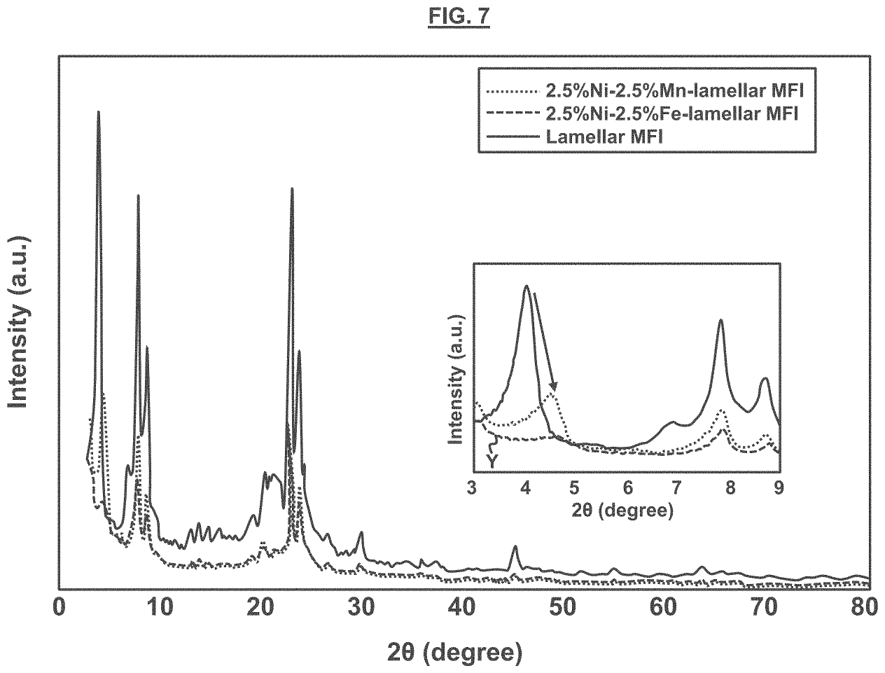

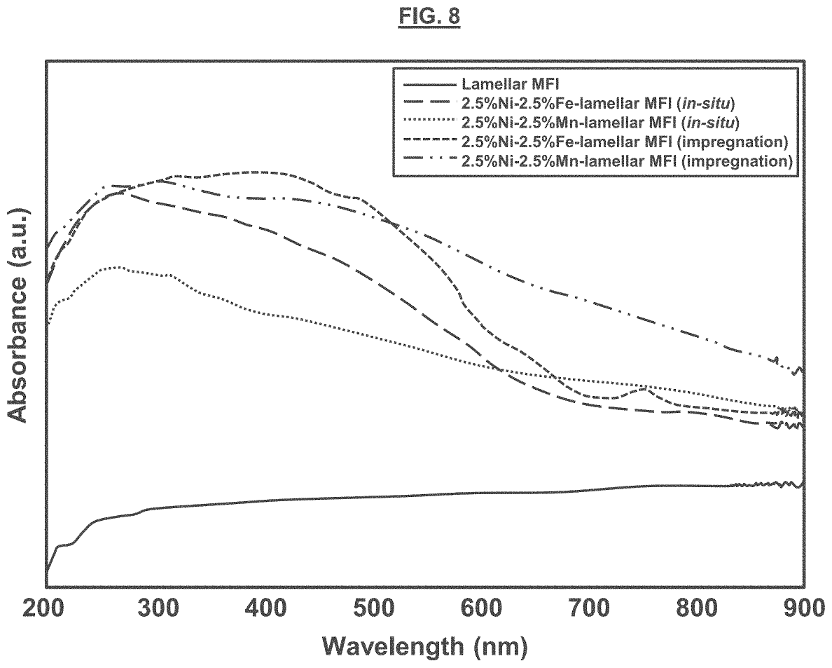

FIGS. 7 and 8 demonstrate analytical results of the synthesized samples showing that the lamellar zeolite structure produced in accordance with the embodiments herein is successfully formed in the presence of bimetal precursors in the zeolite synthesis solution (in agreement with the SEM images shown in FIGS. 6C through 6F) and the bimetals are present in the zeolite framework (shifts of the XRD peaks and UV-Vis peaks assigned to each of the metals compared to the reference materials), thereby producing demonstrably improved results over the conventional lamellar MFI production techniques.

FIG. 7 is a graphical representation of wide-angle XRD patterns of lamellar MFI, 2.5% Ni-2.5% Fe-lamellar MFI, and 2.5% Ni-2.5% Mn-lamellar MFI zeolites synthesized using the one-step hydrothermal synthesis method 100 described above with reference to FIG. 1. The inset graph in FIG. 7 shows the shift of the XRD peaks for bimetal-containing lamellar zeolites compared to the lamellar zeolite. FIG. 7 shows that the XRD patterns of metal-containing lamellar MFI zeolites is similar to the XRD patterns of conventional lamellar MFI zeolite confirming their highly crystallized structure which is not affected by the presence of metals in these zeolites. Slight shifting of the XRD peaks to the higher angles for metal-containing lamellar zeolites compared to the conventional lamellar zeolite is due to the change of zeolite lattice parameters as a result of insertion of metals in the zeolite framework.

FIG. 8 shows the UV-Vis spectra of lamellar MFI, 2.5% Ni-2.5% Fe-lamellar MFI, and 2.5% Ni-2.5% Mn-Lamellar MFI zeolites synthesized using the one-step hydrothermal synthesis method 100 described above with reference to FIG. 1. The UV-Vis spectra of 2.5% Ni-2.5% Fe-Lamellar MFI and 2.5% Ni-2.5% Mn-Lamellar MFI zeolites synthesized from conventional lamellar MFI using the impregnation technique have been presented in this figure for comparison purposes. The results shown in FIG. 8 demonstrate the improvement in absorbance achieved by the presence of metals in zeolites synthesized in accordance with the method 100 provided by the embodiments herein. No characteristic peak is observed for the metal in the UV-Vis spectrum of conventional lamellar MFI as expected, but these peaks are present for metal-containing lamellar MFI zeolites that were synthesized by the conventional impregnation technique or method 100. The broader range of peaks observed for metal species in UV-Vis spectra of impregnated lamellar zeolites compared to those observed for lamellar zeolites synthesized using method 100 shows that the conventional impregnation technique forms both framework and extra-framework metal species, while method 100 is more successful in adding the metals into the zeolite framework. These framework metal sites are supposed to have higher catalytic performance in comparison to extra-framework metal.

The synthesized catalysts produced in accordance with the embodiments herein can be effectively utilized in the oxidation of aromatic compounds such as benzene and deoxygenation of biomass derived compounds such as phenols. The embodiments herein provide for isolated bimetal sites, which can be incorporated to lamellar zeolite structures using a one-step hydrothermal synthesis method 100. The resulting catalyst shows an efficient catalytic performance due to the multi-functionality that it has due to the presence of both incorporated-metals and active sites of the zeolite (due to the presence of aluminum in zeolite structure which makes the zeolite an active acid catalyst) and also the unique meso-/microporous structure of zeolite originating from its lamellar structure. The embodiments herein provide a useful technique for synthesizing materials to reduce the coke formation and increase the catalyst activity, selectivity, and catalyst lifetime for upgrading the biomass to value added chemicals and fuels. The conventional techniques for incorporation of two metals to a zeolite support is a wet impregnation method, which results in the metal oxide formation on the zeolite catalyst instead of the incorporation of the metal in the zeolite framework. Conversely, the embodiments herein provide a technique in which two different types of metals can be incorporated to the framework of the lamellar zeolite structure successfully without the formation of a significant amount of metal oxides in the resulting catalyst.

The bimetallic-containing zeolite catalysts developed in accordance with the embodiments herein can be utilized for the effective conversion of biomass (e.g., wood, trees, grass, etc.) and/or waste streams (e.g., plastic, paper, etc.) to value added chemicals/fuels, which eventually results in the development of compact energy systems. The compact energy systems can reduce the energy logistic costs as well as increase the range and endurance of robotic autonomous platforms. Moreover, the techniques provided by the embodiments herein can provided for high catalytic activity, selectivity, and stability of the resulting materials, which can enable commercial synthesis of value-added chemicals and fuels from biomass.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

What is claimed is:

1. A method to incorporate a bimetal to a lamellar MFI zeolite structure, the method comprising:
providing a bimetallic-incorporated lamellar zeolite catalyst comprising a sodium source, an aluminum source, a silicon source, a surfactant, sulfuric acid, deionized (DI) water, a metal source, and a molecular template;
dissolving the sodium source in the DI water to create a basic solution;
adding the sulfuric acid, the aluminum source, the molecular template, and the silicon source to the basic solution to create a mixture and then adding the metal source to the mixture in the basic solution;
dissolving the surfactant in the DI water to create a surfactant solution;
combining the surfactant solution with the basic solution;
heating the combined surfactant solution and the basic solution in a rotating autoclave to create a metal-containing zeolite including the surfactant and the molecular template in the structure of the metal-containing zeolite;
removing a synthesized zeolite from the autoclave;
drying the synthesized zeolite to create a dry zeolite powder;
calcining the dry zeolite powder to remove the surfactant and the molecular template to create a bimetal-containing lamellar MFI zeolite structure; and
chemically activating the bimetal-containing lamellar MFI zeolite structure.

2. The method of claim 1, wherein the bimetal-containing lamellar MFI zeolite structure comprises micropores of less than 1 nm and mesopores of 2-50 nm.

3. The method of claim 1, wherein the sodium source comprises sodium hydroxide.

4. The method of claim 1, wherein the aluminum source comprises aluminum sulfate.

5. The method of claim 1, wherein the silicon source comprises tetraethyl orthosilicate (TEOS).

6. The method of claim 1, wherein the metal source comprises a metal nitrate solution.

7. The method of claim 1, wherein the surfactant comprises a polyquaternary ammonium structure of [C₂₂H45-N⁺(CH₃)₂-C₆H₁₂-N⁺(CH₃)₂-C₆H₁₃]Br₂, C₂₂₋₆₋₆.

8. The method of claim 1, wherein the molecular template comprises tetrapropylammonium hydroxide (TPAOH).

9. The method of claim 1, wherein the bimetallic-incorporated lamellar zeolite catalyst comprises metal dopants containing any of (i) Ni and Fe, and (ii) Ni and Mn.

10. The method of claim 1, wherein a weight percent of each metal in the bimetallic-incorporated lamellar zeolite catalyst that is synthesized is between 0-2.5.

11. The method of claim 1, wherein the heating occurs at a temperature of 150° C.

12. The method of claim 1, wherein the autoclave rotates at a speed of 30 rpm.

13. The method of claim 1, wherein the heating occurs for 5 days.

14. The method of claim 1, wherein an amount of the bimetal-containing lamellar MFI zeolite structure that is produced from 30 mL of the combined surfactant solution and basic solution is 1-1.8 g.

15. The method of claim 1, comprising cooling metal-containing zeolite at ambient room temperature prior to removal of the synthesized zeolite from the autoclave.

16. The method of claim 1, comprising washing and centrifugation of the synthesized zeolite prior to the drying, wherein the washing and centrifugation occur in DI water until a pH of 9 is obtained.

17. The method of claim 1, wherein, after drying, the synthesized zeolite is calcined at 600° C. for 6 hours to remove the surfactant and the molecular template.

18. The method of claim 1, comprising activating the bimetal-containing lamellar MFI zeolite structure by performing a catalyst preparation process comprising:
performing an ion-exchange process on the calcined dry zeolite powder;
drying an ion-exchanged zeolite powder; and
activating the dry zeolite powder prior to running a catalytic reaction thereon.

19. The method of claim 18, wherein the ion-exchange process comprises:
(a) dissolving an ammonium nitrate powder in DI water to create a 1M ammonium nitrate solution;
(b) mixing the calcined dry zeolite powder with the 1M ammonium nitrate solution having a weight ratio of 1 to 10 to create an ion-exchange mixture;
(c) heating the ion-exchange mixture at 80° C. for 2 hours;
(d) washing and centrifugation of the ion-exchange mixture with DI water to separate zeolite from the ion-exchange mixture; and
(e) repeating the steps (b) through (d) multiple times.

20. The method of claim 18, comprising heating the dry zeolite powder after ion-exchange at 550° C. for 4 hours to activate the dry zeolite powder.
